(19) United States
(12) Patent Application Publication
(10) Pub. No.: US 2022/0092630 A1
(43) Pub. Date: Mar. 24, 2022

(54) DIGITAL SIGNAGE TERMINAL

(71) Applicant: TOSHIBA TEC KABUSHIKI KAISHA, Tokyo (JP)

(72) Inventor: Yasuhiko MOCHIDA, Numazu Shizuoka (JP)

(21) Appl. No.: 17/381,699

(22) Filed: Jul. 21, 2021

(30) Foreign Application Priority Data
Sep. 24, 2020 (JP) 2020-160101

(51) Int. Cl. G06Q 30/02; H04W 4/80; G06Q 20/32

(52) U.S. Cl. CPC G06Q 30/0235; H04W 4/80; G06Q 30/0238; G06Q 20/3276; G06Q 20/3278; G06Q 30/0224

(57) ABSTRACT

According to one or more embodiments, a signage terminal includes a display device and a controller. The display device displays product information. The controller detects a portable terminal within a detection range of the signage terminal and outputs benefit information in a case where a duration of stay of the portable terminal within the detection range is equal to or greater than a predetermined duration of time.

### CROSS-REFERENCE TO RELATED APPLICATIONS

This application is based upon and claims the benefit of priority from Japanese Patent Application No. 2020-160101, filed Sep. 24, 2020, the entire contents of which are incorporated herein by reference.

### FIELD

Embodiments described herein relate generally to a digital signage terminal and a non-transitory computer-readable medium storing a program for controlling a digital signage terminal.

### BACKGROUND

Conventionally, in a retail store, such as a supermarket, information about a product may be displayed on a signage terminal for sales promotion activity, advertising, or the like. The signage terminal informs a customer about a product's value and/or availability to enhance the customer's willingness to purchase products.

However, since paying attention to the signage terminal consumes the customer's time, it may be required for the signage terminal to provide some other added value to the customer beyond just the display of product information.

### BRIEF DESCRIPTION OF THE DRAWINGS

FIG. 1 is a diagram depicting a coupon provision system according to an embodiment.

FIG. 2 is a block diagram of a portable terminal according to an embodiment.

FIG. 3 is a block diagram of a signage terminal according to an embodiment.

FIG. 4 depicts an example data configuration of an image data master according to an embodiment.

FIG. 5 depicts an example data configuration of an action record table according to an embodiment.

FIG. 6 is a block diagram of a signage terminal and a portable terminal of a coupon provision system according to an embodiment.

FIG. 7 is a flowchart of display processing executed by a signage terminal according to an embodiment.

### DETAILED DESCRIPTION

In general, according to one or more embodiments, a digital signage terminal includes a display device and a controller. The display device displays product information. The controller detects a portable terminal within a detection range of the signage terminal and outputs benefit information when a stay duration for the portable terminal is equal to or greater than a predetermined duration of time.

Hereinafter, some example embodiments of a signage terminal and a program as well as a coupon provision system that incorporates the signage terminal and/or the program will be described in detail with reference to the accompanying drawings. These embodiments of a signage terminal, a program and a coupon provision system do not limit the present disclosure.

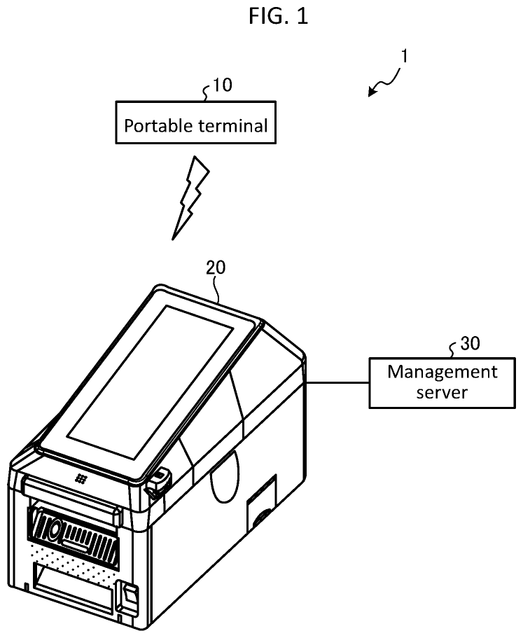

FIG. 1 is a diagram showing an example of a coupon provision system 1 according to one example embodiment. The coupon provision system 1 is one example of a customer benefit provision system and provides a benefit or a privilege, such as a coupon, to a customer. The coupon provision system 1 includes a portable terminal 10, a signage terminal 20, and a management server 30. The portable terminal 10 and the signage terminal 20 can communicate with each other by short-range wireless communication. The signage terminal 20 and the management server 30 are communicably connected to each other. The signage terminal 20 may be referred to as a digital sign, digital signage, a digital signage terminal, or the like.

The portable terminal 10 can be carried by a customer, examples of which include, but are not limited to, a smartphone and a tablet terminal. The portable terminal 10 is not necessarily owned by a customer. It may be a terminal prepared by a store, such as a cart-type point of sales (POS) having a tablet POS terminal mounted on a shopping cart which a customer can use while shopping at the store.

The signage terminal 20 displays information related to a product. The signage terminal 20 detects the portable terminal 10 that is present within a detection range of the signage terminal 20. The detection range is, for example, defined by a predetermined distance from the signage terminal 20. The signage terminal 20 issues benefit information when a predetermined duration of time elapses after the portable terminal 10 is detected. The benefit information refers to a privilege that can be given to the customer or information a customer/shopper may consider beneficial. For example, the benefit information may be coupon for a product, special event information for a store, a cooking recipe including a particular product or type of product, information about similar products, or the like.

In addition, by detecting the portable terminal 10, the signage terminal 20 records an action or a behavior of the customer who uses the detected portable terminal 10 at the store. For example, the signage terminal 20 records duration of stay, specific start of stay, and the like of the customer staying around the signage terminal 20. Then, the signage terminal 20 transmits the record of the action (may also be referred to as an action history) of the customer to the management server 30.

The management server 30 may comprise an information processing device such as a personal computer or a server device. The management server 30 manages the coupon provision system 1. For example, the management server 30 determines effects of the signage terminal 20 displaying the product information including the benefit information based on the customer action record received from the signage terminal 20.

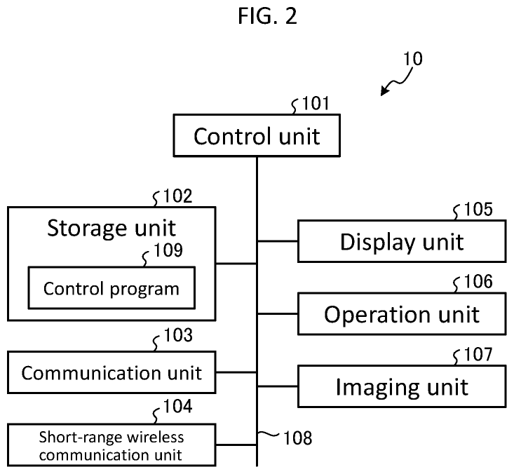

FIG. 2 is a block diagram of an example configuration of the portable terminal 10 according to the present embodiment. The portable terminal 10 includes a control unit 101, a storage unit 102, a communication unit 103, a short-range wireless communication unit 104, a display unit 105, an operation unit 106, and an imaging unit 107. These units are connected to each other via a system bus 108 such as a data bus or an address bus.

The control unit 101 may comprise a control device or a controller that functions as or constitutes a computer that controls the operation of the portable terminal 10 and that realizes various functions of the portable terminal 10. The control unit 101 includes a Central Processing Unit (CPU), a Read-Only Memory (ROM), and a Random-Access Memory (RAM). The CPU controls the operation of the portable terminal 10. The ROM is a storage medium that stores various programs and data. The RAM is a storage medium that temporarily stores various programs and various data. The CPU executes various programs stored in, for example, the ROM or the storage unit 102 using the RAM as a work area.

The storage unit 102 may comprise a storage device such as a flash memory. The storage unit 102 stores a control program 109. The control program 109 causes, when executed by the CPU, the control unit 101 to run an operating system or perform various functions of the portable terminal 10 according to the present embodiment.

The communication unit 103 is an interface for communicating with other devices, such as the management server 30, via a network.

The short-range wireless communication unit 104 may comprise a short-range wireless communication device, such as a wireless communication interface, that performs short-range wireless communication. For example, the short-range wireless communication unit 104 executes the wireless communication according to a communication standard such as Bluetooth®, Wi-Fi, or Near-field communication (NFC). The wireless communication may follow other communication protocols.

The display unit 105 may comprise a display device such as a liquid crystal display. The operation unit 106 is an input device such as a touch pad that receives various operations by detecting a touch location on a screen of the display unit 105. The control panel 106 may be a hardware button or the like.

The imaging unit 107 may comprise a camera including an imaging element such as a Complementary Metal-Oxide Semiconductor (CMOS) or a Charge-Coupled Device (CCD). The imaging unit 107, for example, reads a product code for uniquely identifying a product by reading a code symbol, such as a barcode, attached to the product.

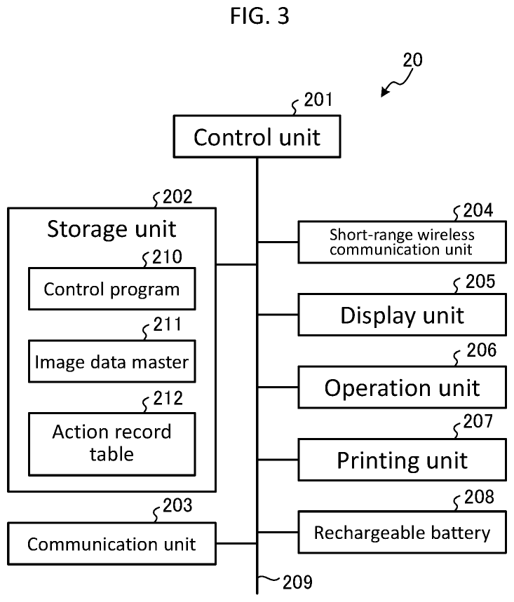

FIG. 3 is a block diagram of an example configuration of the signage terminal 20 according to the present embodiment. The signage terminal 20 includes a control unit 201, a storage unit 202, a communication unit 203, a short-range wireless communication unit 204, a display unit 205, an operation unit 206, a printing unit 207, and a rechargeable battery 208. These components are connected to each other via a system bus 209 such as a data bus or an address bus.

The control unit 201 is a controller or computer that controls the operation of the signage terminal 20 and provided various described functions of the signage terminal 20. The control unit 201 includes a CPU, a ROM, and a RAM. The CPU controls the operations of the signage terminal 20. The ROM is a storage medium that stores various programs and data. The RAM is a storage medium that temporarily stores various programs and various data. The CPU executes various programs stored in, for example, the ROM or the storage unit 202 using the RAM as a work area.

The storage unit 202 may comprise a storage device such as a Hard Disk Drive (HDD) or a Solid-State Drive (SSD). The storage unit 202 stores a control program 210, an image data master 211, and an action record table 212. The image data master 211 and the action record table 212 may be stored in other devices instead of or in addition to the signage terminal 20. The image data master 211 and the action record table 212 may be stored in a plurality of devices in a distributed manner rather than being stored in only one device.

The control program 210 causes, when executed, the control unit 201 perform various functions of the signage terminal 20 according to the present embodiment. The control unit 201 can run the control program 210 in conjunction with an operating system (OS), for example, a real-time OS such as Linux®.

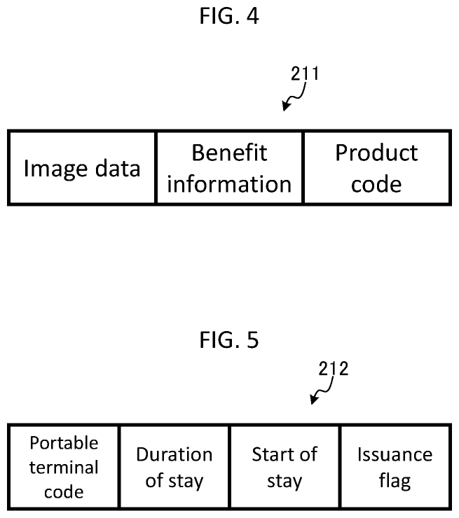

The image data master 211 is an information master including image data to be displayed by the signage terminal 20. FIG. 4 shows an example data configuration of the image data master 211. The image data master 211 is associated with image data, benefit information, and a product code. The image data represents information to be displayed by the signage terminal 20. For example, the image data is of a moving image, one or more still images, or the like. For example, the image data represents information related to a product identified by the associated product code. The benefit information can be a coupon or the like for the associated product. The benefit information may be information of other products from the same manufacturer as that of the associated product, a similar or comparable product to the associated product, a cooking recipe incorporating the associated product, an event at a store (e.g., a special sales event), or the like. The product code represents identification information unique to the product such as a barcode.

The action record table 212 is an information table including a record of an action (also referred to as an action history or action history record) of a customer who uses the portable terminal 10 that has entered the detection range of the signal terminal 20 that is, for example, defined by the predetermined distance from the signage terminal 20. FIG. 5 shows an example data configuration of the action record table 212. In the action record table 212, a portable terminal code, a duration of stay, a start of stay, and an issuance flag are associated with each other. The portable terminal code represents identification information unique to the portable terminal 10 that has entered the detection range and detected by the signal terminal 20. The duration of stay indicates an elapsed time for which the portable terminal 10 identified by the associated portable terminal code stays within the detection range. The start of stay indicates a specific time when the identified portable terminal 10 has entered the detection range. The duration of stay and the start of stay respectively represent how long the stay lasted (customer dwell time) and when the customer using the identified portable terminal 10 entered the detection range around the signage terminal 20 (time of first detection for the present stay). The issuance flag indicates whether or not the benefit information has been issued since the customer with the identified portable terminal 10 began the stay within the detection range.

The communication unit 203 may comprise a communication device such as an interface for communicating with other devices via a network. For example, the communication unit 203 is a network card that connects to a network in a wired or wireless manner.

The short-range wireless communication unit 204 may comprise a short-range wireless communication device, such as a wireless interface, that performs short-range wireless communication. For example, the short-range wireless communication unit 204 executes the wireless communication according to communication standards such as Bluetooth®, Wi-Fi, and NFC. The wireless communication may follow other communication protocols.

The display unit 205 may comprise a display device such as a liquid crystal display. The operation unit 206 may comprise an input device such as a touch pad that receives various operations by detecting a touch position on a screen of the display unit 205. The control panel 206 may be a hardware button or the like.

The printing unit 207 may comprise a printer that prints various information on a printing medium. For example, the printing unit 207 prints out a coupon based on the benefit information.

The rechargeable battery 208 is a chargeable battery such as a lithium-ion battery. Rechargeable battery 208 is charged with electric power that is subsequently used by the signage terminal 20, for example.

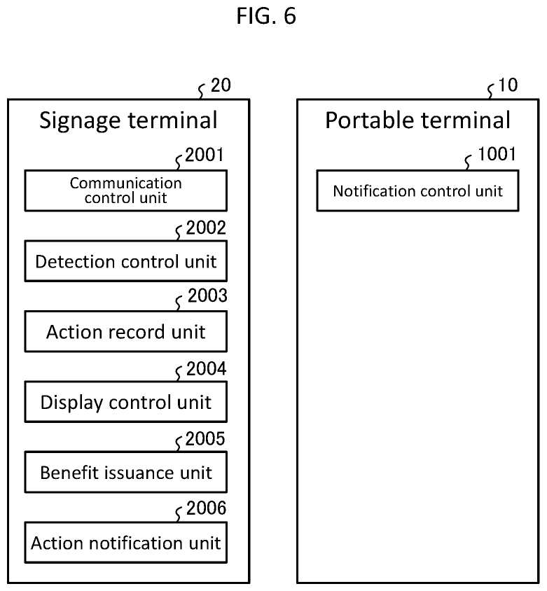

FIG. 6 is a block diagram of another example configuration of the signage terminal 20 and portable terminal 10 of the coupon provision system 1 according to the present embodiment.

In the signage terminal 20, the control unit 201 (see FIG. 3) loads the control program 210 stored in the storage unit 202 into the RAM and operates in accordance with the control program 210 to generate one or more functional units in the RAM. In the example of FIG. 6, such units include a communication control unit 2001, a detection control unit 2002, an action record unit 2003, a display control unit 2004, a benefit issuance unit 2005, and an action notification unit 2006.

The communication control unit 2001 controls the communication unit 203 to execute communication with the management server 30. For example, the communication control unit 2001 transmits the action record table 212 to the management server 30. The communication control unit 2001 is an example of a transmission unit.

The detection control unit 2002 detects the portable terminal 10 within the detection range that is defined by a predetermined distance from the signage terminal 20. The detection control unit 2002 is an example of a detection unit. For example, the detection control unit 2002 detects the portable terminal 10 by short-range wireless communication. In such a case, the detection control unit 2002 controls the short-range wireless communication unit 204 to execute the short-range wireless communication with the portable terminal 10 within the detection range. In one instance, the detection control unit 2002 may receive a portable terminal code from the portable terminal 10 via the short-range wireless communication and determines that the portable terminal 10 is present in the detection range.

The detection control unit 2002 may detect the portable terminal 10 by other methods than the short-range wireless communication. For example, the detection control unit 2002 may detect the portable terminal 10 within the detection range by acquiring position information of the portable terminal 10 using a Global Positioning System (GPS) or the like, or may detect the portable terminal 10 within the detection range by determining whether or not the portable terminal 10 is shown in an image captured by a camera installed at a predetermined position.

The action record unit 2003 records an action history of a person, such as a customer at a store, who carries or uses the detected portable terminal 10. The action record unit 2003 is an example of a record unit. For example, the action record unit 2003 stores the action history of the customer in the action record table 212.

For example, when the detection control unit 2002 receives the portable terminal code from the portable terminal 10, the action record unit 2003 starts measuring the duration of stay during which the portable terminal 10 or the customer with the portable terminal 10 identified by the received code stays within the detection range of the signage terminal 20 defined by the predetermined distance from the signage terminal 20. In this example, the detection control unit 2002 periodically receives the portable terminal code from the portable terminal 10 that is present in the detection range. While the detection control unit 2002 continues receiving the portable terminal code, the action record unit 2003 determines that the customer using the portable terminal 10 of the same portable terminal code is staying within the detection range. When the detection control unit 2002 stops receiving the portable terminal code, the action record unit 2003 determines that the customer has left the detection range and ends the measurement of the duration of stay.

The action record unit 2003 stores the portable terminal code and the duration of stay in the action record table 212 for the portable codes received by the detection control unit 2002. The action record unit 2003 stores at least one of the following times: the time when the detection control unit 2002 initially received the portable terminal code, the time when the portable terminal code is stopped being received, or the length of time the portable terminal code has been continuously received as the duration of stay of information.

Furthermore, when the benefit issuance unit 2005 issues benefit information, the action record unit 2003 changes the issuance flag in the action record table 212 to a state showing that benefit information has been issued.

The display control unit 2004 controls the display unit 205 to display information of the product identified by the product code. The display control unit 2004 is an example of a display control unit. For example, the display control unit 2004 displays information, such as image data included in the image data master 211, on the display unit 205. The display control unit 2004 changes the image data to be displayed according to the action record table 212 or the action history recorded in the action record table 212. For example, the display control unit 2004 selects the image data from the image data master 211 when the action records or histories of a plurality of customers accumulated in the action record table 212 satisfy a change condition. Then, the display control unit 2004 controls the display unit 205 to display the selected image data. The change condition is predetermined and stored in the signage terminal 20 in advance. The change condition includes, for example, a threshold derived by quantifying actions of a plurality of customers. Such a threshold may be a threshold of an average duration of stay among the plurality of customers, a threshold of a number of detected portable terminals 10 per unit time, or the like.

In one instance, when the average duration of stay of the plurality of customers is less than the threshold set as the change condition, there is a possibility that a customer is less interested in the image data displayed on the display unit 205 of the signage terminal 20. Therefore, the display control unit 2004 changes the image data to be displayed on the display unit 205. Then, until the average duration of stay becomes equal to or greater than the threshold, that is, until the image data is displayed that the customers shows a greater interest, the display control unit 2004 repeatedly changes the image data. That is, the display control unit 2004 repeatedly executes a change of the image data until the customers are highly interested in the presently displayed image data. As a result, it is possible to further enhance customer's willingness to purchase the product(s) related to the displayed image data.

Alternatively, the display control unit 2004 may change the display time for the image data. For example, if the display time of the image data is long, the customer may not view the image data for the entire length of the display. Thus, the display control unit 2004 may adjust the display time for different images such that those the customers tend to find less interesting are display for shorter times or less frequently. Furthermore, the display control unit 2004 may change the benefit information associated with the image data in the image data master 211 in accordance with the change of the display time. Accordingly, the display control unit 2004 can cause the benefit issuance unit 2005 to issue benefit information suitable for the display time of the image data. Alternatively, the display control unit 2004 may change audio volume of the image data.

In still another instance, the display control unit 2004 may control the operation unit 206 to receive an operation of selecting a product to be displayed on the display unit 205. In this case, the display control unit 2004 selects the image data associated with the product code of the selected product from the image data master 211 and causes the display unit 205 to display the selected image data. The display control unit 2004 may further cause the display unit 205 to display a layout of a sales floor, a product shelf, or the like of the store based on product display (or product exhibit) information that have been prepared and saved in the signage terminal 20 or the management server 30 in advance and receive customer's operation of selecting, from the displayed sales floor layout or the like, a location of a product which the customer may be interested in. Then, the display control unit 2004 selects, from the image data master 211, the image data associated with the product code of the product at the specific location in the sales floor layout or the like identified by the received operation.

The benefit issuance unit 2005 outputs benefit information corresponding to a privilege or customer benefit when the stay duration within the detection range of the portable terminal 10 as detected by the detection control unit 2002 is equal to or longer than the predetermined duration of time. The benefit issuance unit 2005 is an example of an output unit. The duration of time can be arbitrarily determined and set in advance by an administrator or the like of the signage terminal 20. For example, in a case where the image data is a moving image or a video, the duration of time used to determine whether to issue the benefit information may be a playback time of the video.

The benefit issuance unit 2005 controls, for example, the printing unit 207 to print a coupon indicated by the benefit information. For example, the benefit issuance unit 2005 may print a coupon indicating a price discount amount of a product, a discount rate of a product, or the like on a label sheet. Then, a customer can attach the coupon printed on the label paper to the product or show the coupon to a store clerk, a cashier, or the like at the time of payment. The benefit issuance unit 2005 can also execute the discount of the price of the product during an accounting process operated by the store clerk or the like based on the issued benefit information.

The benefit issuance unit 2005 may issue the benefit information by other methods. For example, the benefit issuance unit 2005 may transmit the benefit information to the mobile terminal 10 by short-range wireless communications.

If the availability of the benefit information, such as for a coupon corresponding to the particular benefit information, is limited to those customers who have viewed the image data of the identified product some predetermined duration of time, the benefit issuance unit 2005 outputs the benefit information including the portable terminal code that uniquely identifies the target portable terminal 10 detected by the detection control unit 2002, that is the portable terminal 10 being used by the target customer. For example, the benefit issuance unit 2005 issues the benefit information including a code symbol, such as a two-dimensional code, as the portable terminal code of the target portable terminal 10. The issued code symbol is displayed on, for example, the display unit 105 of the target portable terminal 10. Then, at the time of accounting or payment processing, an accounting device or the like that executes the accounting processing collates the portable terminal code acquired when reading the benefit information code symbol to the portable terminal code acquired when reading the code symbol displayed on the display unit 105 of the target portable terminal 10. The accounting device applies the benefit information to the accounting processing only if the two portable terminal codes match. If the two portable terminal codes do not match, the accounting device does not execute the application of the benefit information. This way, the benefit issuance unit 2005 can accurately issue the benefit information assigned only to a specific target customer who viewed the image data of the identified product, and such benefit information can be applied to the accounting processing only for that customer.

If the detection control unit 2002 detects multiple portable terminals 10 that have stayed in the detection range of the signage terminal 20 for the predetermined duration of time, the benefit issuance unit 2005 issues the respective benefit information each assigned to the corresponding portable terminals 10. In such a case, to identify which portable terminal 10 or which customer the benefit information belongs to, the benefit issuance unit 2005 issues the benefit information that includes information for identifying each of the target portable terminals 10 or each of the target customers, such as a target portable terminal code uniquely assigned to each portable terminal 10.

Referring back to FIG. 6, the action notification unit 2006 of the signage terminal 20 causes the communication control unit 2001 to transmit the action record table 212 or the content thereof to the management server 30 according to a notification condition. The notification condition may be a specific time, a fixed period of time, or the like that have been arbitrarily determined and set in advance. For example, the action notification unit 2006 instructs the communication control unit 2001 for the transmission of the action record table 212 at the specific time or at every time period. This enables the management server 30 to derive how many customers among the customers who have entered the detection range have been issued the benefit information. Further, the management server 30 can derive the issuance amount of the benefit information or how many times the benefit information has been issued for each time zone.

As to the portable terminal 10 of the coupon provision system 1, the control unit 101 (see FIG. 3) of the portable terminal 10 loads the control program 109 stored in the storage unit 102 into the RAM and operates according to the control program 109 to generate one or more functional units in the RAM. In the example of FIG. 6, such units include a notification control unit 1001 among others (not separately depicted).

The notification control unit 1001 notifies a portable terminal code indicating its own portable terminal 10 when entering the detection range. For example, the notification control unit 1001 sends the portable terminal code to the signage terminal 20 when the short-range wireless communication unit 104 establishes the short-range wireless communication with the short-range wireless communication unit 204 of the signage terminal 20.

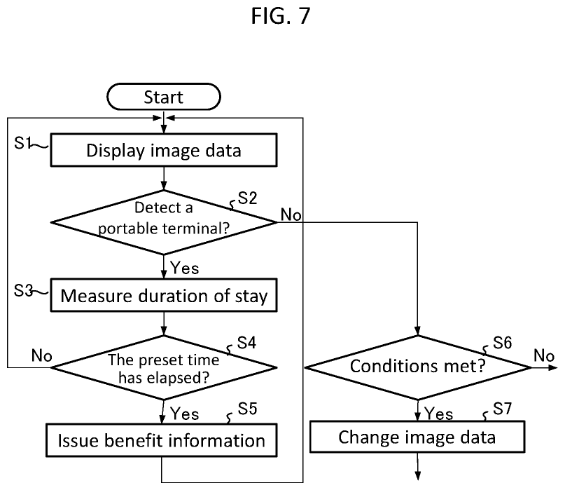

FIG. 7 is a flowchart of display processing executed by the signage terminal 20 according to the present embodiment.

The display control unit 2004 causes the display unit 205 to display the image selected from the plurality of images stored in the image data master 211 (Step S1).

The detection control unit 2002 determines whether the portable terminal 10 has entered the detection range of the signage terminal 20 (Step S2).

When the portable terminal 10 is detected in the detection range (Step S2; Yes), the action record unit 2003 starts measuring a duration of stay during which the portable terminal 10 stays within the detection range (Step S3). The action record unit 2003 ends the measurement of the duration of stay when the portable terminal 10 is not detected within the detection range.

The benefit issuance unit 2005 determines whether the measured duration of stay has exceeded the predetermined duration of time (Step S4). If the duration of stay has not reached the predetermined duration of time (Step S4; No), the benefit issuance unit 2005 returns to step S1.

Once the duration of stay reaches the predetermined duration of time (Step S4; Yes), the benefit issuance unit 2005 issues benefit information (Step S5). Then, signage terminal 20 returns to step S1 thereafter.

In step S2, if the portable terminal 10 is not detected (Step S2; No), the display control unit 2004 determines whether a condition for changing the image (a change condition) on the display unit 205 has been satisfied (Step S6). If the change condition has not been satisfied (Step S6; No), the signage terminal 20 returns to Step S1.

If the change condition is satisfied (Step S6, YES), the display control unit 2004 changes the image on the display unit 205 based on the action record table 212 (Step S7). For example, the display control unit 2004 selects the image data to be displayed on the display unit 205 from the image data master 211 based on the action record table 212. Then, the signage terminal 20 returns to step S1.

As described above, the signage terminal 20 according to the present embodiment causes the display unit 205 to display image data that has been selected from the image data master 211. The signage terminal 20 detects the portable terminal 10 present in the detection range of the signage terminal 20. When the portable terminal 10 stays within the detection range for the predetermined duration of time, the signage terminal 20 determines that the customer carrying the portable terminal 10 has viewed the image data and issues benefit information such as a coupon. This way, the signage terminal 20 can issue the coupon or the like as a benefit to a customer who has viewed the image data displayed by the signage terminal 20 at least for the predetermined duration of time. Therefore, the signage terminal 20 can provide an added value than just a display of product information.

The program(s) executed by each device of the embodiments and examples may be incorporated in advance in a storage medium (e.g., ROM or other storage unit) included in each device, but is not limited thereto. For example, the program may be recorded in a non-transitory computer-readable recording medium such as a CD-ROM, a flexible disk (FD), or a CD-R, Digital Versatile Disk (DVD) as a file in an installable format or an executable format. The storage medium may be accessible via a LAN, the Internet, or the like and downloaded.

In addition, the program(s) executed by each device may be stored on a computer connected to a network such as the Internet and downloaded via the network, or may accessed or distributed via the network such as the Internet.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A digital signage terminal, comprising:
a display device configured to display images including product information; and
a controller configured to:
detect a portable terminal within a detection range of the digital signage terminal; and
output benefit information if a stay duration for the portable terminal within the detection range is greater than or equal to a predetermined length of time.

2. The digital signage terminal according to claim 1, wherein the controller detects the portable terminal using short-range wireless communication interface configured to communicate with the portable terminal.

3. The digital signage terminal according to claim 1, wherein the benefit information is output to the portable terminal by the short-range wireless communication.

4. The digital signage terminal according to claim 1, wherein the controller is further configured to:
record an action history corresponding to a person carrying the detected portable terminal, the action history including the stay duration of the detected portable terminal, and
cause the action history to be transmitted a management server.

5. The digital signage terminal according to claim 4, wherein the controller selects image data to be displayed by the display device according to the action history.

6. The digital signage terminal according to claim 1, wherein the controller outputs the benefit information including identification information of the detected portable terminal.

7. The digital signage terminal according claim 1, further comprising:
a printing unit configured to print information associated with the benefit information when the benefit information is output to the printing unit by the controller.

8. The digital signage terminal according to claim 1, wherein
the controller outputs the benefit information to the display device, and
the display device displays the benefit information as a two-dimensional code readable by the portable device.

9. A non-transitory computer-readable medium storing a program therein that, when executed, causes a processor of a digital signage terminal to perform a method comprising:
displaying product information on a display screen;
detecting a portable terminal within a predetermined range from the display screen; and
outputting benefit information corresponding to the product information being displayed on the display screen if stay duration the portable terminal within the predetermined range is equal to or greater than a predetermined duration of time.

10. The non-transitory computer-readable medium according to claim 9, wherein the predetermined range is a wireless communication range for wireless communications between the digital signage terminal and the portable terminal.

11. The non-transitory computer-readable medium according to claim 10, wherein the method further comprises:
receiving a portable terminal code from the portable terminal at the digital signage terminal via wireless communication.

12. The non-transitory computer-readable medium according to claim 10, wherein the method further comprises:
outputting the benefit information to the portable terminal stays by wireless communication.

13. The non-transitory computer-readable medium according to claim 10, wherein the method further comprises:
recording an action history corresponding to a person who uses the detected portable terminal, the action history including the stay duration for the detected portable terminal.

14. The non-transitory computer-readable medium according to claim 13, wherein the method further comprises:
transmitting the action history to a management server.

15. The non-transitory computer-readable medium according to claim 13, wherein the method further comprises:
changing image data to be displayed on the display screen according to the action history.

16. The non-transitory computer-readable medium according to claim 9, wherein the method further comprises:
outputting the benefit information via display of a two-dimensional code on the display screen.

17. A customer benefit provision system, comprising:
a digital signage terminal configured to:
display images including product information,
detect a portable terminal within a predetermined range of the digital signage terminal,
issue benefit information associated with the product information when a stay duration of the portable terminal within the predetermined range is a predetermined duration or longer, and
record an action record table including the stay duration for the portable terminal and whether or not the benefit information associated with the product information was issued to the detected portable terminal; and
a management server connected to the digital signage terminal and configured to receive the action record table from the digital signage terminal.

18. The customer benefit provision system according to claim 17, wherein the digital signage terminal transmits the action record table to the management server based on a notification condition.

19. The customer benefit provision system according to claim 17, wherein the digital signage terminal detects the portable terminal by short-range wireless communication.

20. The customer benefit provision system according to claim 19, wherein the digital signage terminal receives a portable terminal code from the portable terminal via the short-range wireless communication.
